(19) United States
(12) Patent Application Publication
(10) Pub. No.: US 2006/0023986 A1
(43) Pub. Date: Feb. 2, 2006

(54) Thrust roller bearing and method of manufacturing the same

(75) Inventor: Katsuhiko Chihara, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 11/188,639

(22) Filed: Jul. 26, 2005

(30) Foreign Application Priority Data
Jul. 27, 2004 (JP) P. 2004-218319

(51) Int. Cl. F16C 33/58; F16C 33/46; F16C 33/76

(52) U.S. Cl. 384/621

(57) ABSTRACT

A thrust roller bearing includes a race and a cage that retains a plurality of rollers and is disposed on the race. The race includes: an annular plate portion defining a raceway for the plurality of rollers, a flange that is extended in an axial direction thereof and provided at a radially outer side or a radially inner side of the annular plate portion, and an annular locking portion that is provided at an entire periphery on a front end of the flange and is projected in a radial direction thereof in such a manner that the annular locking portion catches a radially outer side or a radially inner side of the cage in the axial direction. Only the annular plate portion is softer than the annular plate portion.

### BACKGROUND OF THE INVENTION

The present invention relates to a thrust roller bearing in which a cage for holding a plurality of rollers a race are non-separable and a method of manufacturing the same.

According to a thrust roller bearing of this kind, generally, in order to make a cage and a race non-separable, a flange along an axial direction is provided on a radially outer side or a radially inner side of the race, and a plurality of claws directed inward in a radial direction for catching a radially outer side or a radially inner side of the cage in the axial direction are provided at a plurality of portions in a circumferential direction of a front end of the flange (refer to, for example, Japanese Utility Model Publication H05-94527).

The race, generally, is harden by a heat treatment in a semi-finished state in which, for example, the flange of an annular plate is bended. Thereafter, the claws are formed by locally heating the plurality of portions in the circumferential direction of the flange by a high frequency induction coil and processing the flange. In this case, local heating needs to be carried out in order to form the claws, which increases a number of steps and amounts to an increase in cost. Further, when the race and the cage are assembled, the race and the cage are forcibly assembled by warping the claws of the cage, and since the claws are warped in this way, there is a concern of separating the race and the cage by impacting the thrust roller bearing in carrying the thrust roller bearing.

In contrast thereto, it is conceivable to provide an annular locking portion over an entire periphery on a front end side of the flange in place of the claws provided at the plurality of portions in the circumferential direction of the flange. However, in this case, the cage cannot be assembled to the race. Therefore, the thrust roller bearing is assembled in such a manner that the race is brought into a semi-finished state in which the annular locking portion is not formed at the flange, an assembly comprising a plurality of rollers and the cage is assembled with the race in the semi-finished state and the annular locking portion is formed at the flange of the race, thereby the race and the assembly are prevented from being separated from each other. In order to carryout such assembly, similar to the above-described related art, processing for forming the annular locking portion at the front end side of the flange needs to be carried out by locally heating the front end side of the flange of the race after subjecting a total of the race in the semi-finished state to the hardening heat treatment, which increases a number of steps and amounts to an increase in cost.

### SUMMARY OF THE INVENTION

An object of the invention is to provide a thrust roller bearing having a structure in which an assembly comprising a plurality of rollers and a cage and a race are made to be difficult to be separated from each other.

In order to solve the aforesaid object, the invention is characterized by having the following arrangement.
(1) A thrust roller bearing comprising:
   a race; and
   a cage that retains a plurality of rollers and is disposed on the race,
   wherein the race comprises:
      an annular plate portion defining a raceway for the plurality of rollers,
      a flange that is extended in an axial direction thereof and provided at a radially outer side or a radially inner side of the annular plate portion, and
      an annular locking portion that is provided at an entire periphery on a front end of the flange and is projected in a radial direction thereof in such a manner that the annular locking portion catches a radially outer side or a radially inner side of the cage in the axial direction, and
   wherein an entire circumference of the flange and an entire circumference of the annular locking portion are softer than the annular plate portion.
(2) The thrust roller bearing according to (1), wherein the annular plate portion, the flange and the annular locking portion are integrally formed.
(3) The thrust roller bearing according to (1), wherein the flange and the annular locking portion are continuously tapered toward a front end of the annular locking portion.
(4) The thrust roller bearing according to (1), wherein only the annular plate portion is subjected to a hardening heat treatment to make the entire circumference of the flange and the entire circumference of the annular locking portion softer than the annular plate portion.
5. The thrust roller bearing according to (1), wherein an inner diameter of the annular locking portion is smaller than an outer diameter of the cage.
(6) A method of manufacturing a thrust roller bearing, the method comprising:
   providing a cage which retains a plurality of rollers;
   providing an annular base material to be a race comprising an annular plate portion defining a raceway, a flange and an annular locking portion;
   bending the base material to form the flange which is extended in an axial direction thereof from the annular plate portion;
   subjecting only the annular plate portion to a hardening heat treatment;
   after the bending and subjecting steps, assembling the cage which retains the plurality of rollers into the race; and
   bending an entire periphery of a front end of the flange to form the annular locking portion which is projected in a radial direction thereof in such a manner that the annular locking portion catches a radially outer side or a radially inner side of the cage in the axial direction.
(7) The method according to (6), wherein the hardening heat treatment is locally carried out by a high frequency induction heating coil.
(8) A thrust roller bearing manufactured by a method, the method comprising:
   providing a cage which retains a plurality of rollers;
   providing an annular base material to be a race comprising an annular plate portion defining a raceway, a flange and an annular locking portion;
   bending the base material to form the flange which is extended in an axial direction thereof from the annular plate portion;
   subjecting only the annular plate portion to a hardening heat treatment;
   after the bending and subjecting steps, assembling the cage which retains the plurality of rollers into the race; and
   bending an entire periphery of a front end of the flange to form the annular locking portion which is projected in a radial direction thereof in such a manner that the annular locking portion catches a radially outer side or a radially inner side of the cage in the axial direction.

According to the present invention, the hardening heat treatment refers to a heat treatment for ensuring a hardness requested as the race. Although there are metal materials used as a base material of the race which are subjected to a heat treatment for controlling a basic property thereof and which are not subjected to a heat treatment with an object of controlling the basic property (raw material), the base materials using both of them are included in the invention. Therefore, although there are a case in which the flange and the annular locking portion are not subjected to a heat treatment at all as in the raw material and a case in which the flange and the annular locking portion are subjected to a heat treatment with an object of controlling the basic property, in either of the cases, the flange and the annular locking portion are made to be softer than the annular plate portion subjected to the hardening heat treatment

In this case, since the entire periphery of the front end side of the flange is provided with the annular locking portion, the assembly comprising the plurality of rollers and the cage and the race are not separated from each other so far as, for example, the annular locking portion is deformed. Further, although wear resistance of the roller track face is promoted by hardening only the annular plate portion constituting the roller track face of the plate by the heat treatment, the flange and the annular locking portion of the race are not softened by the heat treatment and therefore, the race and the assembly comprising the plurality of rollers and the cage can be assembled before forming the annular locking portion of the race and the annular locking portion can easily be formed after the assembly. Thereby, an unseparable structure can inexpensively be provided.

According to the invention, in providing the annular locking portion, the flange of the race is not locally heated as in the related art and therefore, a number of steps can be reduced in comparison with that of the background art and production cost can be reduced. Further, the annular locking portion is formed by assembling the assembly comprising the plurality of rollers and the cage to the race before forming the annular locking portion at the race, the annular locking portion in not warped as in the claw of the background art and therefore, there is not a concern of separating the assembly and the race.

According to the thrust roller bearing and the method of manufacturing the same of the invention, a structure of making the assembly comprising the plurality of rollers and the cage and the race difficult to be separated from each other can inexpensively be provided

### BRIEF DESCRIPTION OF THE DRAWINGS

FIG. 1 is a plane view showing a thrust roller bearing according to a best mode for carrying out the invention.

FIG. 2 is a view viewing a section taken along a line (2)-(2) of FIG. 1 by arrow marks.

FIG. 3 is a view viewing a section taken along a line (3)-(3) of FIG. 1 by arrow marks.

FIG. 4 is a perspective view enlarging to show a periphery of a pocket of a cage of FIG. 1.

FIG. 5 is a view of a step showing an example of a method of manufacturing the thrust roller bearing of FIG. 1.

FIG. 6 is a view of a step shown successive to FIG. 5.

FIG. 7 is a view of a step shown successive to FIG. 6.

FIG. 8 is a view of a thrust roller bearing manufactured by a procedure from FIG. 5 to FIG. 7 in correspondence with FIG. 2.

FIG. 9 is a view of a thrust roller bearing according to still other embodiment of the invention in correspondence with FIG. 2.

### DETAILED DESCRIPTION OF PREFERRED EMBODIMENTS

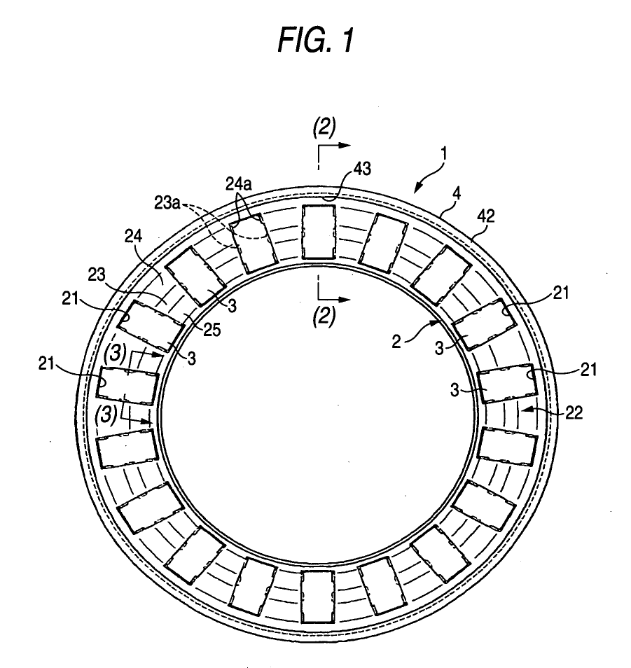

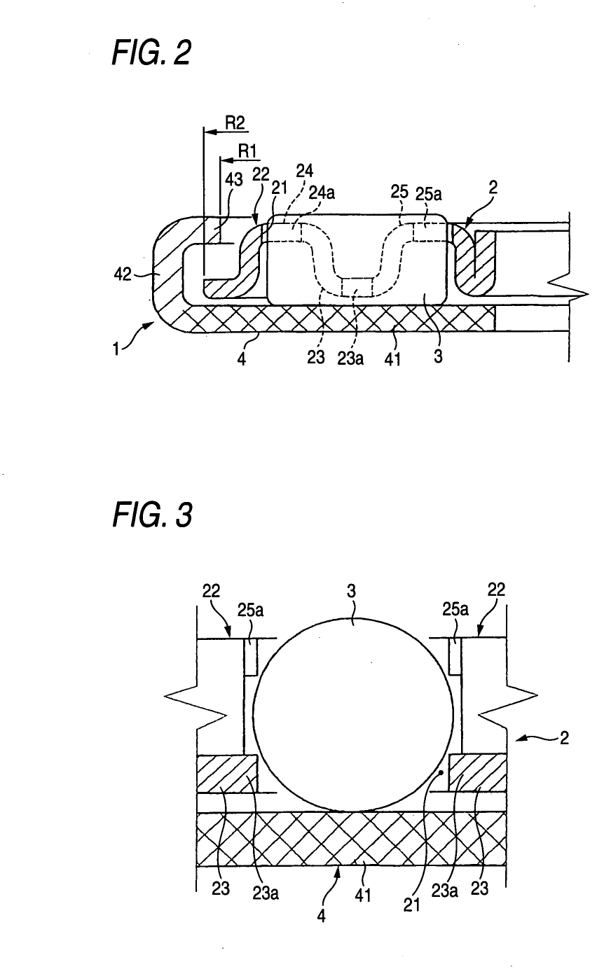

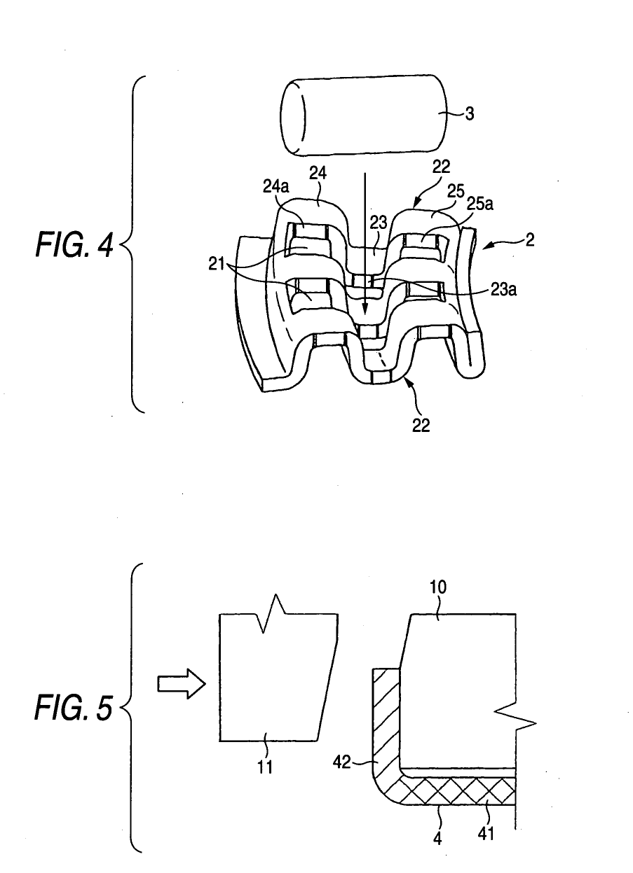

A best mode for carrying out the invention will be described with reference to the drawings hereinafter. FIG. 1 is a plane view showing a thrust roller bearing, FIG. 2 is a view viewing a section taken along a line (2)-(2) of FIG. 1 by arrow marks, FIG. 3 is a view viewing a section taken along a line (3)-(3) of FIG. 1 by arrow marks, and FIG. 4 is a perspective view enlarging to show a periphery of a pocket of a cage of FIG. 1.

A thrust roller bearing 1 shown in the drawings is provided with a cage 2, a plurality of rollers 3, and a single race 4.

The cage 2 is made from one annular sheet plate. Pockets 21 substantially in a rectangular shape in a plane view for retaining the rollers 3 are provided at a plurality of portions in a circumferential direction of a middle region in a radial direction thereof. Pillar portions 22 are provided between the respective adjacent pockets 21 in the circumferential direction. The pillar portion 22 is bent in a wavy shape in the radial direction and is provided with a middle expanded portion 23 expanded to one side in an axial direction at a middle in the radial direction, and a radially outer side expanded portion 24 and a radially inner side expanded portion 25 which are expanded to other side in the axial direction and located on opposite sides in the radial direction.

The rollers 3 are rotatably retained in the pocket 21 of the cage 2 to be prevented from being separated therefrom. That is, at the pillar portion 22, a total of three portions of the middle expanded portion 23, the radially outer side expanded portion 24 and the radially inner side expanded portion 25 are provided with claws 23a, 24a, 25a projected into the pocket 21. With the claws 23a, 24a, 25a, widths of the respective pockets 21 in the circumferential direction at the three portions in the radial direction of each pocket become smaller than the diameter of the roller 3, thereby, the roller 3 is prevented from being drawn out from inside of the pocket 21 to both sides in the axial direction. Further, the roller 3 is assembled into the pocket 21 inseparably therefrom by being forcibly fitted to the pocket 21.

Although the roller 3 is of a type in which a shape of an end face thereof is referred to as a plane type, also the roller 3 the shape of the end face of which is constituted by a spherical shape will do.

The race 4 is provided with a flange 42 extended in the axial direction from a radially outer side of an annular plate portion 41 constituting a raceway of the roller 3. An entire periphery on a front end side of the flange 42 is provided with an annular locking portion 43 projected inward in the radial direction. The cage 2 is inseparably assembled into the race 4.

That is, an inner diameter R1 of the annular locking portion 43 of the race 4 is set to be smaller than an outer diameter R2 of the cage 2, and thus the annular locking portion 43 and the cage 2 interfere with each other in the axial direction Therefore, the race 4 and an assembly comprising the plurality of rollers 3 and the cage 2 are prevented from being separated from each other.

Particularly, since the annular locking portion 43 is provided to the front end of the flange 42 of the race 4 continuously in the circumferential direction, the assembly can firmly be prevented from being detached to draw out so far as the annular locking portion 43 is not deformed. Therefore, product reliability is remarkably provided in comparison with that of the related art in which the claws are provided at the plurality of portions in the circumferential direction of the race.

Meanwhile, in the case of the race 4 having the annular locking portion 43 continuous in the circumferential direction in this way, it is physically difficult to assemble the assembly to the race 4. Hence, a method of manufacturing the above-described thrust roller bearing 1 is constituted as follows and therefore, the method will be explained.

First, the race 4 in a semi-finished state provided only with the flange 42 is prepared. As a base material of the race 4, there is, for example, a carbon steel material (SC material) for a mechanical structure, a tool steel (SK material) or the like. Only the annular plate portion 41 of the race 4 is locally subjected to a heat treatment to be hardened by a high frequency induction heating coil. The portion subjected to the hardening heat treatment in this way is shown by cross hatchings in the drawing. At this stage, the flange 42 of the race 4 is not hardened by the heat treatment and therefore, the flange 42 becomes softer than the annular plate portion 41. The race 4 and the assembly are prevented from being separated from each other by forming the annular locking portion 43 by assembling the assembly comprising the plurality of rollers 3 and the cage 2 into the race 4 in the semi-finished state and thereafter bending the entire periphery of the front end side of the flange 42 of the race 4 inward in the radial direction. The annular locking portion 43 is formed by bending the front end of the flange 42 which is not hardened in this way and therefore, the bending can simply be carried out.

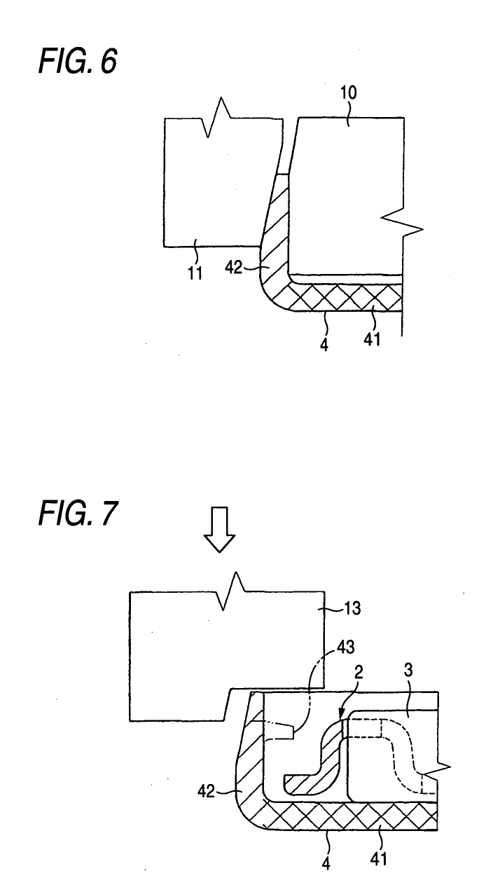

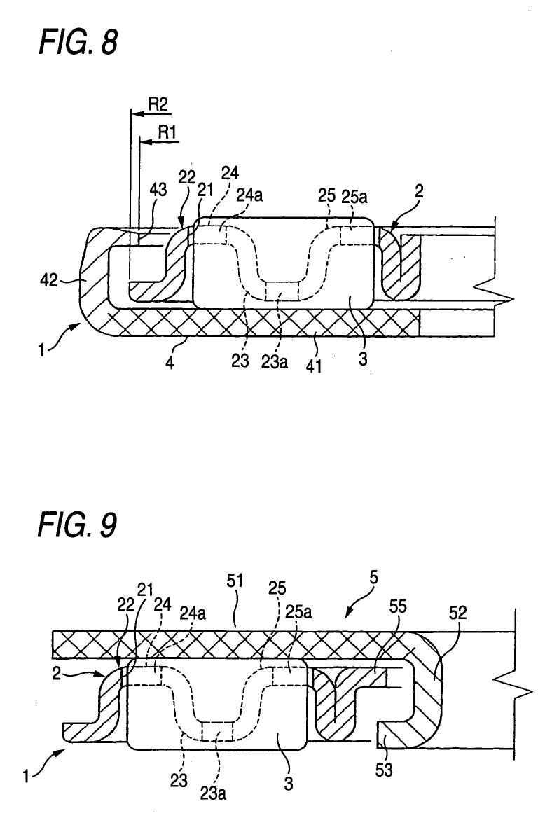

In a step of forming the annular locking portion 43, as shown in, for example, FIG. 5 through FIG. 7, an outer peripheral face on the front end of the flange 42 may be thin-walled by contracting a diameter thereof by setting a receiving die 10 to an entire inner peripheral face of the flange 42 of the race 4 and pressing the front end side of the flange 42 inwardly in a radial direction by a pressing die 11 from a radially outer side. The annular locking portion 43 is formed by bending the front end of the flange 42 by a pressing die 13 shown in FIG. 7. In this case, there is achieved an advantage of capable of carrying out the operation of bending the annular locking portion 43 further simply than the above-described and capable of working the annular locking portion 43 accurately. FIG. 8 shows a sectional view of a half of the thrust roller bearing 1 manufactured in this way.

When manufactured by such a method, only the annular plate portion 41 of the race 4 is subjected to the hardening heat treatment, the flange 42 and the annular locking portion 43 are not subjected to the hardening heat treatment and therefore, as a result, the flange 42 and the annular locking portion 43 become softer than the annular plate portion 41.

As described above, according to the embodiment, the annular locking portion 43 is provided at the entire periphery of the front end side of the flange 42 of the race 4 and therefore, the assembly comprising the plurality of rollers 3 and the cage 2 and the race 4 are not separated from each other so far as, for example, the annular locking portion 43 is not deformed. Further, although the wear resistance of the roller track face is promoted by hardening only the annular plate portion 41 constituting the raceway of the race 4 by the heat treatment, the flange 41 and the annular locking portion 43 of the race 4 are not hardened by the heat treatment and therefore, the race 4 and the assembly comprising the plurality of rollers 3 and the cage 2 can be assembled before forming the annular locking portion 43 of the race 4 and the annular locking portion 43 can easily be formed after the assembly. Thereby, the unseparable structure can inexpensively be provided.

Meanwhile, the hardening heat treatment of the annular plate portion 41 of the race 4 is not limited only to the method of using the high frequency induction heating coil but the hardening heat treatment can be constituted by normal quenching, carburizing quenching, nitrizing quenching, carburizing and nitrizing quenching or the like. However, in the cases of the quenching, it is necessary to mask a portion other than the annular plate portion 41 of the race 4 to be prevented from being quenched. Further, in this case, there is achieved an advantage in view of cost in comparison with the case of heating to soften the annular plate portion 41 before forming the annular locking portion as in the related art.

Another embodiments of the invention will be explained as follows
(1) FIG. 9 shows another embodiment of the invention. A race 5 provided with a flange 52 on a radially inner side of an annular plate portion 51 is used for the thrust roller bearing 1 according to the embodiment. The race 5 is provided with an annular locking portion 53 projected outwardly in a radial direction over an entire periphery of the front end side of the flange 52. Further, the cage 2 is provided with an extended portion 55 extended inwardly in a radial direction on a radially inner side thereof, and the extended portion 55 is caught in an axial direction by the annular locking portion 53 of the race 5. In this case, operation and effect similar to those of the above-described embodiment are achieved. Further, in the embodiment, similar to FIG. 5 through FIG. 8, the annular locking portion 53 may be formed by making the front end side of the flange 52 thin-walled and thereafter bending the front end side.
(2) A sectional shape of the cage 2 is not particularly limited. Further, the cage 2 may not be constituted by one sheet product but may be constructed by a generally-known constitution of integrating two annular plates.

What is claimed is:

1. A thrust roller bearing comprising:
a race; and
a cage that retains a plurality of rollers and is disposed on the race,
wherein the race comprises:
an annular plate portion defining a raceway for the plurality of rollers,
a flange that is extended in an axial direction thereof and provided at a radially outer ide or a radially inner side of the annular plate portion, and
an annular locking portion that is provided at an entire periphery on a front end of the flange and is projected in a radial direction thereof in such a manner that the annular locking portion catches a radially outer side or a radially inner side of the cage in the axial direction, and
wherein an entire circumference of the flange and an entire circumference of the annular locking portion are softer than the annular plate portion.

2. The thrust roller bearing according to claim 1, wherein the annular plate portion, the flange and the annular locking portion are integrally formed.

3. The thrust roller bearing according to claim 1, wherein the flange and the annular locking portion are continuously tapered toward a front end of the annular locking portion.

4. The thrust roller bearing according to claim 1, wherein only the annular plate portion is subjected to a hardening heat treatment to make the entire circumference of the flange and the entire circumference of the annular locking portion softer than the annular plate portion.

5. The thrust roller bearing according to claim 1, wherein an inner diameter of the annular locking portion is smaller than an outer diameter of the cage.

6. A method of manufacturing a thrust roller bearing, the method comprising:
providing a cage which retains a plurality of rollers;
providing an annular base material to be a race comprising an annular plate portion defining a raceway, a flange and an annular locking portion;
bending the base material to form the flange which is extended in an axial direction thereof from the annular plate portion;
subjecting only the annular plate portion to a hardening heat treatment;
after the bending and subjecting steps, assembling the cage which retains the plurality of rollers into the race; and
bending an entire periphery of a front end of the flange to form the annular locking portion which is projected in a radial direction thereof in such a manner that the annular locking portion catches a radially outer side or a radially inner side of the cage in the axial direction.

7. The method according to claim 6, wherein the hardening heat treatment is locally carried out by a high frequency induction heating coil.

8. A thrust roller bearing manufactured by a method, the method comprising:
providing a cage which retains a plurality of rollers;
providing an annular base material to be a race comprising an annular plate portion defining a raceway, a flange and an annular locking portion;
bending the base material to form the flange which is extended in an axial direction thereof from the annular plate portion;
subjecting only the annular plate portion to a hardening heat treatment;
after the bending and subjecting steps, assembling the cage which retains the plurality of rollers into the race; and
bending an entire periphery of a front end of the flange to form the annular locking portion which is projected in a radial direction thereof in such a manner that the annular locking portion catches a radially outer side or a radially inner side of the cage in the axial direction.
